(19) United States
(12) Patent Application Publication
(10) Pub. No.: US 2026/0266111 A1
(43) Pub. Date: Sep. 10, 2026

(54) CHOCK WITH LIGHTING ELEMENT

(71) Applicant: BOLT Rescue LLC, Wayne, NJ (US)

(72) Inventor: David V. Leporini, Wayne, NJ (US)

(21) Appl. No.: 19/351,213

(22) Filed: Oct. 6, 2025

Related U.S. Application Data
(63) Continuation-in-part of application No. PCT/US2024/023189, filed on Apr. 5, 2024.
(60) Provisional application No. 63/457,785, filed on Apr. 6, 2023.

(51) Int. Cl. E05C 17/54; E05C 17/00; F21V 19/00; F21V 21/08; F21Y 115/10

(52) U.S. Cl. CPC E05C 17/54; E05C 17/025; F21V 19/0055; F21V 21/08; F21Y 2115/10

(57) ABSTRACT

Devices for maintained an entryway are provided. Such devices may include a chock including a substantially flat member and a securing member with a receiving channel. The receiving channel may be situated over a hinge pin between a door and a jamb. The device may further include a lighting element.

### CROSS REFERENCE TO RELATED APPLICATION

The present application is a continuation-in-part of International Application No. PCT/US2024/023189, filed Apr. 5, 2024, which claims priority under 35 USC 119 to US provisional application number 63/457,785, which was filed Apr. 6, 2023, both of which are incorporated by reference in it entirety.

The present disclosure relates to a device for maintaining a door in an open position. More particularly, the present disclosure is directed to a chock paired with an optional light that is configured to maintain a door in an open position.

There are concerns among first responders regarding maintaining access to a building through a doorway. Closed doorways present both safety and security issues during emergency situations. Existing solutions to maintain open doorways may not provide a sufficiently large entry and may fail when exposed to excessive heat or force. First responders may encounter further hazards during emergencies including smoke or insufficient lighting.

Therefore, there exists an unmet need for device to provide safe access into and out of a doorway. Accordingly, the present disclosure provides for a device that maintains an open doorway with illumination.

### SUMMARY

A device for holding a doorway or entryway open is provided. The device may be used by anyone wishing to secure a door open, but is particularly useful for first responders such as firemen or others who may enter a building in an emergency situation where smoke or other hazards may be present.

The device can comprise a substantially flat member comprising a first angled side wall and a second angled side wall; a securing member coupled to the flat member; a receiving channel situated within the securing member, the receiving channel comprising an arcuate opening extending from an edge of the securing member substantially perpendicular to the flat member. The device is configured such that when the receiving channel is secured to a door one of the angled side walls abuts a hinge plate on the door and the other angled side wall abuts a hinge plate of a door jamb, preventing closure of the door. The device can optionally include a lighting element adjacent to the flat member opposite the securing member.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 is an exploded view of a lighting element, according to some embodiments.

FIG. 2 is an internal view of the lighting element of FIG. 1.

FIG. 3 includes views of a chock, according to some embodiments.

FIG. 4 includes views of a chock paired with a lighting element, according to some embodiments.

FIG. 5 depicts a chock paired with a lighting element and inserted between a door and a jamb, according to some embodiments.

FIG. 6 depicts a front view of a chock with a rechargeable light.

FIG. 7 depicts a side view of the chock of FIG. 6.

FIG. 8 depicts a perspective view of the chock of FIG. 6 with an activated light.

FIG. 9 depicts the chock of FIG. 6 inserted between a door and a jamb, according to some embodiments.

### DETAILED DESCRIPTION OF CERTAIN EXEMPLARY EMBODIMENTS

Reference will now be made in detail to certain exemplary embodiments according to the present disclosure, certain examples of which are illustrated in the accompanying drawings. Wherever possible, the same reference numbers will be used throughout the drawings to refer to the same or like parts.

In this application, the use of the singular includes the plural unless specifically stated otherwise. In this application, the use of “or” means “and/or” unless stated otherwise. Furthermore, the use of the term “including”, as well as other forms, such as “includes” and “included”, is not limiting. Similarly, the use of the term “comprising,” as well as other forms, such as “comprises,” is also not limiting. Any range described herein will be understood to include the endpoints and all values between the endpoints.

The section headings used herein are for organizational purposes only and are not to be construed as limiting the subject matter described. All documents, or portions of documents, cited in this application, including but not limited to patents, patent applications, articles, books, and treatises, are hereby expressly incorporated by reference in their entirety for any purpose.

According to some embodiments, a device for maintaining an open doorway with illumination is provided. This maintains approximately a sufficiently open entryway when placed on a hinge pin of a door to allow first responders to have save and quick ingress and egress to a building. The device also provides illumination with a lighting element that is visible through smoke.

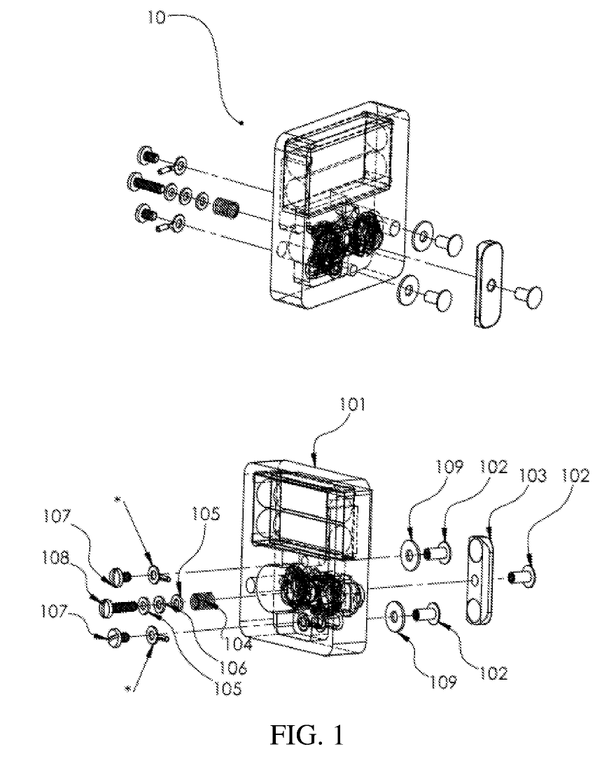

FIG. 1 is an exploded view of a lighting element 10. In some embodiments, lighting element is an LED light. Lighting element 10 may include a body 101 housing the components of the lighting element 10. The components of the lighting element 10 may be coupled to the body 101 with one or more fasteners 102 and washers 109. In some embodiments, the fasteners 102 may be metallic. In some embodiments, the one or more washers 109 are polymeric.

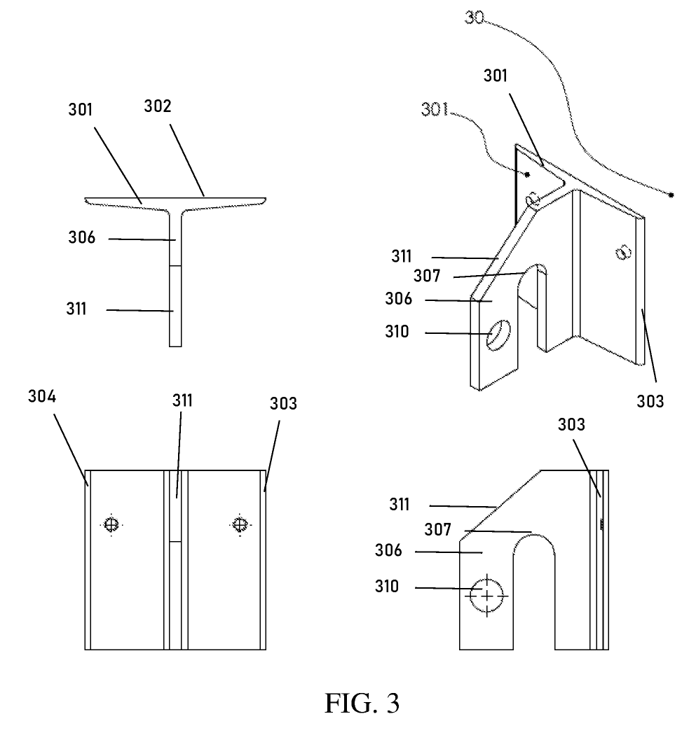

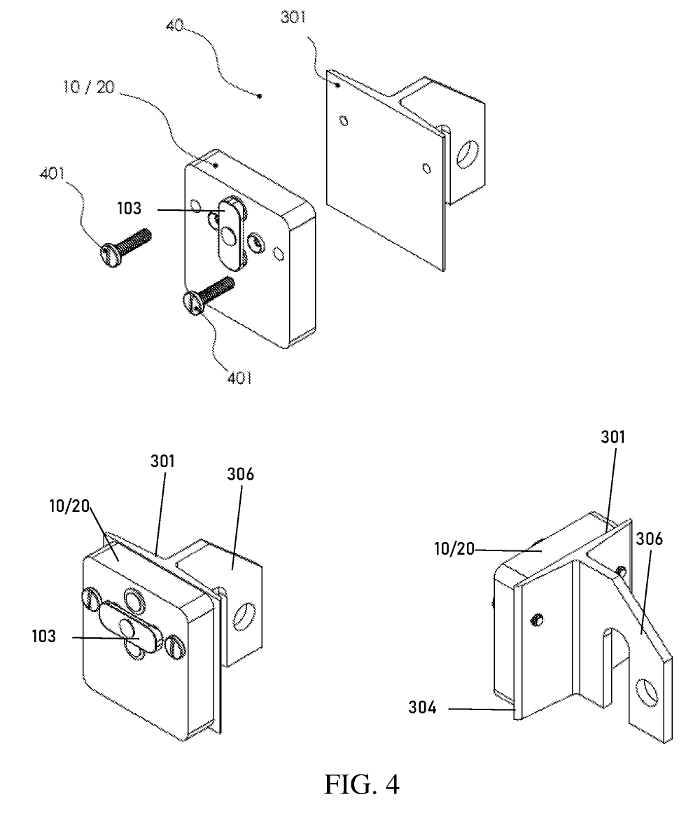

The lighting element 10 may be activated by a switch 103 located on an exterior surface of the lighting element 10. When combined with a chock 30 (described below with respect to FIGS. 3 and 4), the switch 103 of the lighting element 10 may be located on an exterior surface facing away from the chock 30. In some embodiments, the switch 103 may be rotated to activate the light element 10. For example, the switch 103 may be rotated ninety degrees.

The switch 103 may compress a spring 104 to activate the lighting element 10. The spring 104 may be held in place by a screw 108 and one or more washers, for example at least one metallic washer 105, at least one polymeric washer 106, or a combination thereof. The lighting element 10 may further include one or more screws 107 paired with additional washers to secure components within the body 101. In some embodiments, screws 107 and 108 are metallic

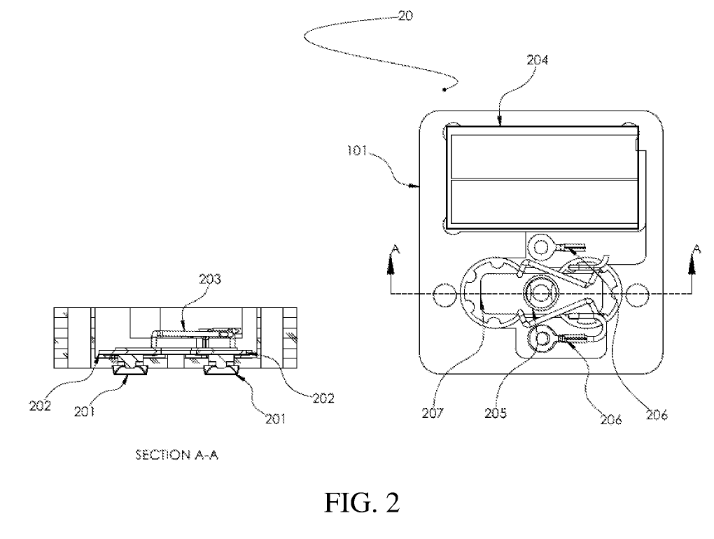

FIG. 2 is an internal view of a lighting element 20. The lighting element 20 may include one or more reflectors 201, for example two or more (e.g., three to eight). The reflectors 201 may reflect light produced by one or more LED lights 202 housed within the body 101. The LED lights 202 may be housed behind the reflectors 201 and held in place by a strap 207. The LED lights 202 may be connected to a power pack 204 by a wire harness 203.

A polymeric sleeve 205 may be situated over the spring 104 and associated screws 107, 108 and washers 105, 106. The polymeric sleeve 205 may be situated adjacent to the strap 207. One or more ring terminals 206 may be connected to the power pack 204 by the wire harness 203.

FIG. 3 includes views of a chock 30. The chock 30 may include a substantially flat member 301. The flat member 301 may include a surface 302. In some embodiments, the surface 302 may be etched. In other embodiments, the surface 302 may be featureless.

The flat member 301 may be rectangular in shape. In further embodiments, the flat member 301 may be in the shape of a square. One or more edges of the flat member 301 may be two, three, four, or five inches in length, or any amount in between. For example, each edge may be 3.25 inches in length, the distance from the inside of a door jamb to the back of the edge of a door open at approximately a 90 degree angle.

The flat member 301 may include at least one of a first angled side wall 303 and a second angled side wall 304. Each side wall 303, 304 may be angled towards the surface of the flat member 301 opposing the surface 302.

The chock 30 further includes a securing member 306 coupled to the flat member 301. The securing member 306 may be situated perpendicular to the flat member 301. The securing member 306 may be coupled to the side of the flat member 301 opposite the surface 302. In some embodiments, the combined flat member 301 and securing member 306 are two, three, four, five, six, seven, or eight inches in length, or any length in between. In some embodiments, the combined flat member 301 and securing member 306 are 2.75 inches thick.

In some embodiments, the securing member 306 is 0.1, 0.2, 0.3, 0.4, or 0.5 inches thick, or any thickness in between. For example, the securing member 306 may be a quarter inch thick.

In some embodiments, the securing member 306 may include an angled edge 311. In some embodiments, the angled edge 311 has a first terminus situated one, two, three, or four inches from the surface 302, or any distance in between. In some embodiments, the angled edge 311 has a first terminus situated 1.25 inches from the surface 302.

In some embodiments, the angled edge 311 has a second terminus at the edge of the securing member 306 furthest from the flat member 301. In some embodiments, the second terminus is situated one, two, three, or four inches from a bottom edge of the securing member 306, or any distance in between. In some embodiments, the second terminus is situated two inches from a bottom edge of the securing member 306.

In some embodiments, the flat member 301 and the securing member 306 may be composed of the same material. For example, the flat member 301 and the securing member 306 may be metallic. In some embodiments, the flat member 301 and the securing member 306 are composed of aluminum. In further embodiments, the flat member 301 and the securing member 306 are composed of 6061 T6 aluminum I Beam.

In some embodiments, the flat member 301 and the securing member 306 are integrally coupled. In other words, the flat member 301 and the securing member 306 are machined together. In other embodiments, the flat member 301 and the securing member 306 are machined separately and joined together, e.g., by welding.

The securing member 306 may include a receiving channel 307 situated within the securing member 306. The receiving channel 307 may include an arcuate opening 308 extending from an edge 309 of the securing member 306 substantially perpendicular to the flat member 301.

The receiving channel 307 is sized and shaped to fit over a hinge pin of a standard door. In some embodiments, the receiving channel 307 is of sufficient length to receive approximately half of a hinge pin. When the chock 30 is secured to a door, first angled side wall 303 abuts a hinge plate on the door and the second angled side wall 304 abuts a hinge plate of a door jamb, preventing closure of the door. The surface 302 faces outward from the hinge pin.

In some embodiments, the chock 30 may be placed on the ground between a door and the associated jamb. In such embodiments, the chock 30 may be sized and shaped to maintain an opening of about 45 degrees between the door and the jamb, for example anywhere between 40-50 degrees.

The securing member 306 may further include an attachment means 310. The attachment means 310 may be sized and shaped to receive an attachment feature, for example a carabiner clip, to attach the chock 30 to a storage device or to a user’s clothing or equipment. For example, a firefighter may attach the chock 30 to a clip on their uniform. In some embodiments, the attachment means 310 is a swivel collar.

FIG. 4 includes views of a chock 40 paired with a lighting element 10, 20. The lighting element 10, 20 may be secured to the chock 40 with one or more screws 401. The screws 401 may pass through the lighting element 10, 20 and through the flat member 301.

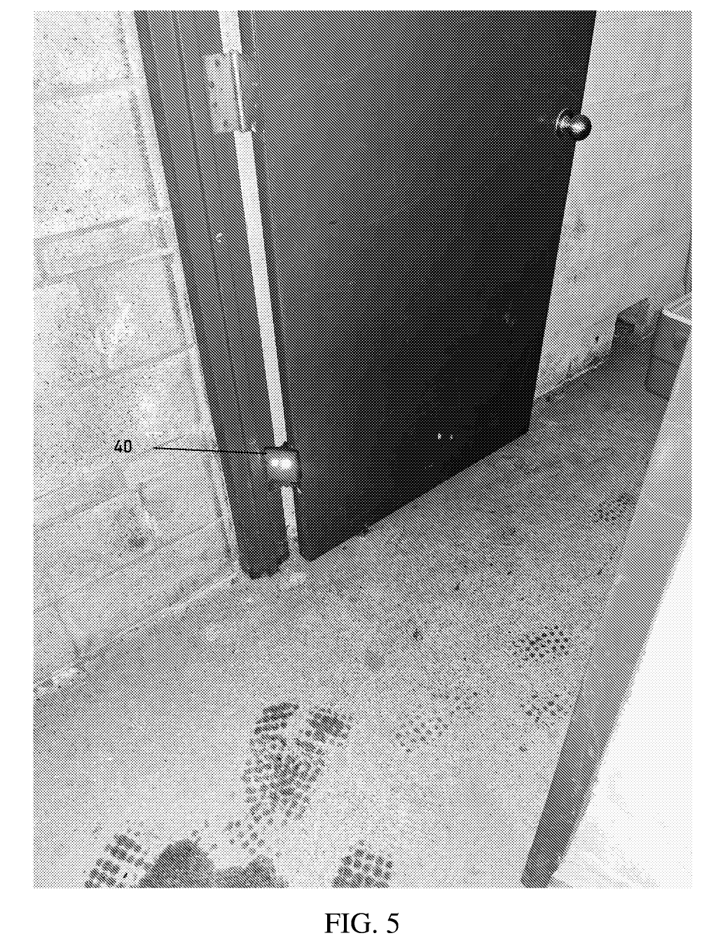

FIG. 5 depicts a chock 40 paired with a lighting element 10, 20 and inserted between a door and a jamb. As can be seen in FIG. 5, the chock 40 is situated on and at least partially around a hinge pin connecting the door and the jamb. The chock 40 prevents the door from moving closer to the jamb. The chock 40 is sized and shaped to maintain an open entryway with the door at an angle anywhere between 85-95 degrees from the jamb. In some embodiments, the door is maintained at a 90 degree angle from the jamb. Because the chock 40 is situated on and at least partially around the hinge pin, the chock 40 stays in position even if force is applied to the door. Additionally, the chock 40 is sized and shaped to be positioned on the hinge pin without further attachment means.

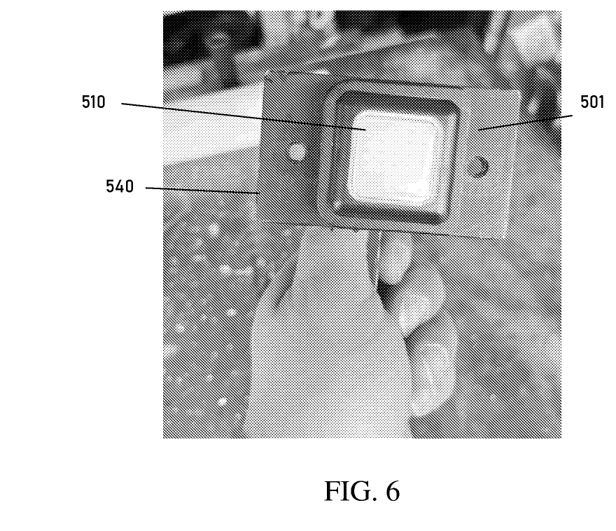

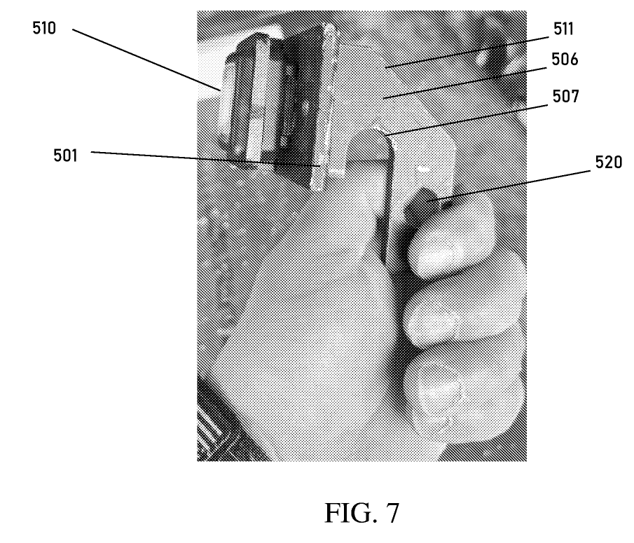

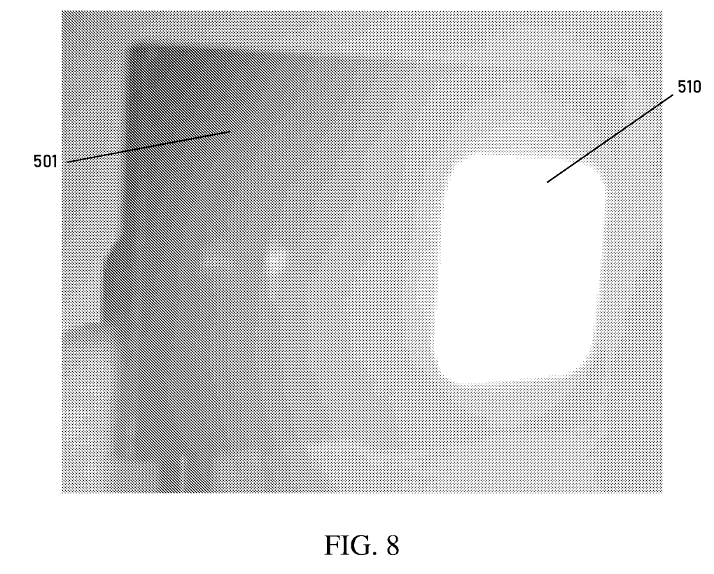

FIGS. 6-9 depict a chock 540 with a rechargeable light 510. The light 510 may be removed from the chock 540 to charge when the chock 540 is not in use. The light 510 may be situated on, around, or adjacent to the center of a flat member 501 of the chock 540.

The flat member 501 may be rectangular in shape. In further embodiments, the flat member 501 may be in the shape of a square. One or more edges of the flat member 501 may be two, three, four, or five inches in length, or any amount in between. For example, each edge may be 3.25 inches in length, the distance from the inside of a door jamb to the back of the edge of a door open at approximately a 90 degree angle.

The chock 540 further includes a securing member 506 coupled to the flat member 501. The securing member 506 may be situated perpendicular to the flat member 501. The securing member 506 may be coupled to the side of the flat member 501 opposite the light 510. In some embodiments, the combined flat member 501 and securing member 506 are two, three, four, five, six, seven, or eight inches in length, or any length in between. In some embodiments, the combined flat member 501 and securing member 506 are 2.75 inches thick.

In some embodiments, the securing member 506 is 0.1, 0.2, 0.3, 0.4, or 0.5 inches thick, or any thickness in between. For example, the securing member 306 may be a quarter inch thick.

In some embodiments, the securing member 506 may include an angled edge 511. In some embodiments, the angled edge 511 has a first terminus situated one, two, three, or four inches from the surface 502, or any distance in between. In some embodiments, the angled edge 511 has a first terminus situated 1.25 inches from the surface 502.

In some embodiments, the angled edge 511 has a second terminus at the edge of the securing member 506 furthest from the flat member 501. In some embodiments, the second terminus is situated one, two, three, or four inches from a bottom edge of the securing member 506, or any distance in between. In some embodiments, the second terminus is situated two inches from a bottom edge of the securing member 506.

In some embodiments, the flat member 501 and the securing member 506 may be composed of the same material. For example, the flat member 501 and the securing member 506 may be metallic. In some embodiments, the flat member 501 and the securing member 506 are composed of aluminum. In further embodiments, the flat member 501 and the securing member 506 are composed of 6061 T6 aluminum I Beam.

In some embodiments, the flat member 501 and the securing member 506 are integrally coupled. In other words, the flat member 501 and the securing member 506 are machined together. In other embodiments, the flat member 501 and the securing member 506 are machined separately and joined together, e.g., by welding.

The securing member 506 may include a receiving channel 507 situated within the securing member 506. The receiving channel 507 may include an arcuate opening extending from an edge of the securing member 506 substantially perpendicular to the flat member 501.

The receiving channel 507 is sized and shaped to fit over a hinge pin of a standard door. In some embodiments, the receiving channel 507 is of sufficient length to receive approximately half of a hinge pin.

In some embodiments, the chock 540 may be placed on the ground between a door and the associated jamb. In such embodiments, the chock 540 may be sized and shaped to maintain an opening of about 45 degrees between the door and the jamb, for example anywhere between 40-50 degrees.

The securing member 506 may further include an attachment means 520. The attachment means 520 may be sized and shaped to receive an attachment feature, for example a carabiner clip, to attach the chock 540 to a storage device or to a user’s clothing or equipment. For example, a firefighter may attach the chock 540 to a clip on their uniform. In some embodiments, the attachment means 520 is a swivel collar.

In some embodiments, attachment means 310 or 520 may be sized to operate as a wrench or key to engage an oxygen tank. In some embodiments, an aperture separate from the attachment means 310 or 520 may operate as a wrench or key to engage an oxygen tank. The aperture may situated proximate to the attachment means 310 or 520.

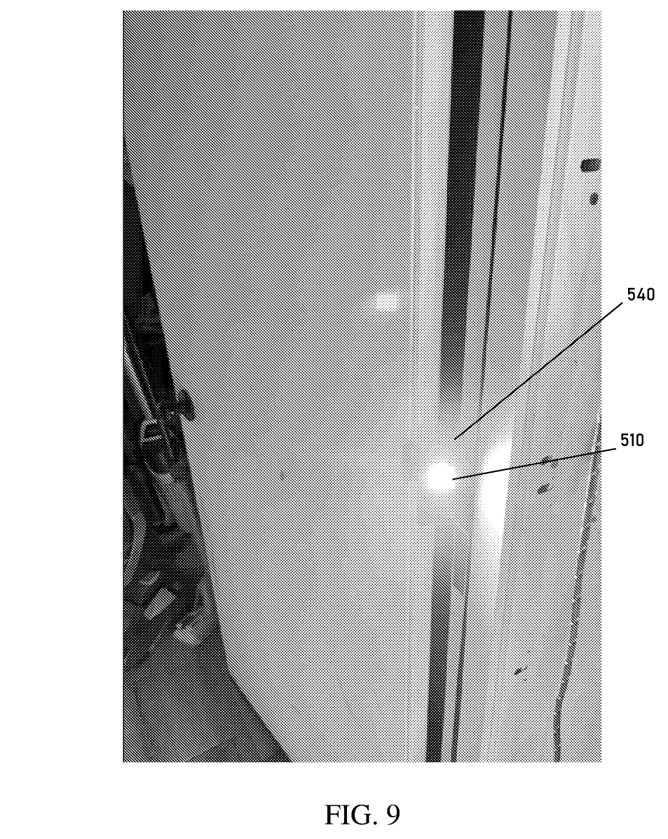

FIG. 9 depicts the chock 540 inserted between a door and a jamb, according to some embodiments. As can be seen in FIG. 5, the chock 540 is situated on and at least partially around a hinge pin connecting the door and the jamb. The chock 540 prevents the door from moving closer to the jamb. The chock 540 is sized and shaped to maintain an open entryway with the door at an angle anywhere between 85-95 degrees from the jamb. In some embodiments, the door is maintained at a 90 degree angle from the jamb. Because the chock 540 is situated on and at least partially around the hinge pin, the chock 540 stays in position even if force is applied to the door. Additionally, the chock 540 is sized and shaped to be positioned on the hinge pin without further attachment means.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

What is claimed is:

1. A device comprising:
a substantially flat member comprising a first angled side wall and a second angled side wall;
a securing member coupled to the flat member;
a receiving channel situated within the securing member, the receiving channel comprising an arcuate opening extending from an edge of the securing member substantially perpendicular to the flat member;
wherein the device is configured such that when the receiving channel is secured to a door one of the angled side walls abuts a hinge plate on the door and the other angled side wall abuts a hinge plate of a door jamb, preventing closure of the door; and
a lighting element adjacent to the flat member opposite the securing member.

2. The device of claim 1, wherein the flat member and the securing member are composed of the same material.

3. The device of claim 2, wherein the flat member and the securing member are composed of aluminum.

4. The device of claim 1, wherein the flat member and the securing member are integrally coupled.

5. The device of claim 1, wherein the receiving channel is sized and shaped to fit around a hinge pin.

6. The device of claim 1, wherein the lighting element is an LED light.

7. The device of claim 1, wherein the lighting element is secured to the flat member by one or more screws.

8. The device of claim 1, wherein the securing member further comprises an attachment means.

9. The device of claim 8, wherein the attachment means is configured to removably attach to an item of clothing.

10. The device of claim 8, wherein the attachment means comprises a swivel collar.

11. The device of claim 1, wherein the device is configured to hold the door open at a ninety degree angle.

12. The device of claim 1, wherein the device is configured to hold the door open at an angle between 85-95 degrees.

13. The device of claim 1, wherein the receiving channel extends at least 1.5 inches from the edge of the securing member that is substantially perpendicular to the flat member.

14. The device of claim 1, wherein the lighting element is rechargeable.
